(19) United States
(12) Patent Application Publication
(10) Pub. No.: US 2015/0249483 A1
(43) Pub. Date: Sep. 3, 2015

(54) WIRELESS POWER TRANSMISSION SYSTEM

(71) Applicant: Murata Manufacturing Co., Ltd., Nagaokakyo-shi (JP)

(72) Inventors: KEIICHI ICHIKAWA, Nagaokakyo-shi (JP); Hironori Sakai, Nagaokakyo-shi (JP)

(21) Appl. No.: 14/699,010

(22) Filed: Apr. 29, 2015

Related U.S. Application Data
(63) Continuation of application No. PCT/JP2013/073610, filed on Sep. 3, 2013.

(30) Foreign Application Priority Data
Dec. 27, 2012 (JP) 2012-284725

(51) Int. Cl. H04B 5/00; H02J 7/00; H02J 7/02; H02J 5/00

(52) U.S. Cl. CPC H04B 5/0037; H02J 5/005; H02J 7/007; H02J 7/025

(57) ABSTRACT

A wireless power transmission system in which power is transmitted from a power transmitting apparatus to a power receiving apparatus that includes: a diode bridge formed of first and second diodes whose anodes are connected to each other, and third and fourth diodes whose cathodes are connected to each other; series circuits formed of semiconductor switching devices and capacitors respectively connected in parallel with the first and second diodes, and a control circuit that inputs a modulation signal to the gates of the semiconductor switching devices. The power transmitting apparatus includes a controller that reads the modulation signal on a basis of a change in a DC current input at an input terminal. The a wireless power transmission system can transmit data from the power receiving apparatus to the power transmitting apparatus without interrupting power transmission, reducing output voltage variations, and suppressing degradation of power transmission characteristics.

### CROSS REFERENCE TO RELATED APPLICATIONS

The present application is a continuation of PCT/JP2013/073610 filed Sep. 3, 2013, which claims priority to Japanese Patent Application No. 2012-284725, filed Dec. 27, 2012, the entire contents of each of which are incorporated herein by reference.

### FIELD OF THE INVENTION

The present invention relates to wireless power transmission systems that enable data communication from a power receiving apparatus to a power transmitting apparatus.

### BACKGROUND OF THE INVENTION

Examples of typical known wireless power transmission systems include magnetic-field-coupling power transmission systems in which power is transmitted from the primary coil of a power transmitting apparatus to the secondary coil of a power receiving apparatus using a magnetic field. However, in this system, when power is transmitted using magnetic field coupling, since electromotive force is strongly influenced by the magnitude of magnetic flux passing through each coil, high accuracy is required in the relative positional relationship between the primary coil and the secondary coil. In addition, since coils are used, it is difficult to reduce the sizes of the apparatuses.

On the other hand, an electric-field-coupling wireless power transmission system has also been proposed, as disclosed in Patent Document 1. In this system, power is transmitted from the coupling electrode of a power transmitting apparatus to the coupling electrode of a power receiving apparatus through an electric field. This method allows the accuracy of the relative positional relationship between the coupling electrodes to be relatively low and allows the sizes and thicknesses of the coupling electrodes to be reduced.

The power transmission system disclosed in Patent Document 1 includes a high-frequency high-voltage generator circuit, a passive electrode, and an active electrode. The power receiving apparatus includes a high-frequency high-voltage load circuit, a passive electrode, and an active electrode. As a result of the active electrode of the power transmitting apparatus and the active electrode of the power receiving apparatus being arranged in such a manner as to be close to each other with a gap therebetween, these two electrodes are coupled to each other through an electric field. The passive electrode of the power transmitting apparatus, the active electrode of the power transmitting apparatus, the active electrode of the power receiving apparatus, and the passive electrode of the power receiving apparatus are arranged in parallel with one another.

In this wireless power transmission system, it is necessary to transmit information about the state (for example, charge level) of the power receiving apparatus to the power transmitting apparatus in some cases, through data communication between the power transmission apparatus and the power receiving apparatus. In this case, a possible method is to perform communication at the same time as power transmission by modulating an AC voltage or an AC current transmitted between the power transmitting apparatus and the power receiving apparatus.
Patent Document 1: Japanese Unexamined Patent Application Publication (Translation of PCT Application) No. 2009-531009

However, in both a magnetic-field-coupling system and an electric-field-coupling system, when an AC voltage or the like is modulated, if simple load modulation using a resistance load is performed, an output voltage varies due to the modulation operation and, hence, it is necessary to interrupt power transmission while transmitting data from the power receiving apparatus to the power transmitting apparatus. In addition, power is consumed by a modulation unit, thereby causing a decrease in power transmission efficiency.

### SUMMARY OF THE INVENTION

It is an object of the present invention to provide a wireless power transmission system that enables data communication between the power transmitting apparatus and the power receiving apparatus, while suppressing variations in output voltage caused by load modulation, without a decrease in power transmission efficiency.

A wireless power transmission system according to the present invention includes: a power transmitting apparatus configured to apply an AC voltage to a power transmitting unit converted from an input DC voltage; and a power receiving apparatus configured to convert into a DC voltage an AC voltage induced in a power receiving unit as a result of an AC voltage being applied to the power transmitting unit by rectifying and smoothing the AC voltage induced in the power receiving unit. The power receiving apparatus includes: a diode bridge formed of first and second diodes whose anodes are connected to each other, and third and fourth diodes whose cathodes are connected to each other; at least one of first series circuits and second series circuits, the first series circuits each being formed of a semiconductor switching device and a capacitor and being respectively connected in parallel with the first and second diodes, and the second series circuits each being formed of a semiconductor switching device and a capacitor and being respectively connected in parallel with the third and fourth diodes; and control means for inputting a modulation signal to control terminals of the semiconductor switching devices. The power transmitting apparatus includes signal reading means for reading the modulation signal on a basis of a change in a transmission current.

With this configuration, the amount of a load on the power receiving apparatus side can be changed by simultaneously switching on/off the semiconductor switches of the first and second series circuits. The power receiving apparatus changes the amount of the load in accordance with data to be transmitted to the power transmitting apparatus, thereby changing the transmission current in the power transmitting apparatus. For example, when data “1” is to be transmitted to the power transmitting apparatus, the load on the power receiving side is made to enter a high-load state, and when data “0” is to be transmitted to the power transmitting apparatus, the load on the power receiving side is made to enter a low-load state. The power transmitting apparatus reads a change in the transmission current, and by detecting a change in the state of the load on the power receiving apparatus side, determines whether the data is “1” or “0”. As a result, data communication from the power receiving apparatus to the power transmitting apparatus based on load modulation is realized. In this case, compared with existing resistance load modulation, variations in the output voltage can be suppressed and power transmission efficiency can be improved.

It is preferable that the power transmitting apparatus include: a DC-AC inverter and a step-up circuit configured to step up an AC voltage converted from a DC voltage by the DC-AC inverter and to apply a stepped-up AC voltage to the transmission unit.

It is preferable that the signal reading means detect the change in the transmission current on a basis of a change in a current input to the power transmitting apparatus. With this configuration, complex signal processing is not needed, since the modulation signal is read on the basis of a change in a DC current.

The power receiving apparatus may include both of the first series circuits and the second series circuits. With this configuration, the power receiving apparatus can generate four-state data (00, 01, 10, and 11), whereby information can be transmitted from the power receiving apparatus to the power transmitting apparatus at a high rate.

A configuration may be employed in which the power transmitting unit includes a power transmitting side active electrode and a power transmitting side passive electrode, and the power receiving unit includes: a power receiving side active electrode configured to face the power transmitting side active electrode with a gap therebetween; and a power receiving side passive electrode configured to face the power transmitting side passive electrode with a gap therebetween or configured to be in direct contact with the power transmitting side passive electrode, and power is transmitted from the power transmitting apparatus to the power receiving apparatus as a result of the power transmitting side active electrode and the power receiving side active electrode facing each other and being coupled to each other through an electric field.

With this configuration, data communication is realized in power transmission that is based on electric field coupling.

A configuration may be employed in which the power transmitting unit includes a power transmitting side coil through which a high-frequency current flows, the power receiving unit includes a power receiving side coil in which a high-frequency current is induced by electromagnetic induction, and power is transmitted from the power transmitting apparatus to the power receiving apparatus as a result of the power transmitting side coil and the power receiving side coil being coupled to each other through a magnetic field.

With this configuration, data communication is realized in power transmission based on magnetic field coupling.

According to the present invention, compared with the case of existing resistance load modulation, it is possible to suppress variations in an output voltage and improve power transmission efficiency.

### BRIEF DESCRIPTION OF DRAWINGS

FIG. 1 is a circuit diagram of a wireless power transmission system according to a first embodiment.

FIG. 2 is a schematic diagram of the wireless power transmission system.

FIG. 3 is a block diagram for describing the controller of a power transmitting apparatus.

FIG. 4 is a diagram illustrating voltage waveforms and a current waveform in the first embodiment.

FIG. 5 is a diagram illustrating voltage waveforms and a current waveform in the case where the driving frequency of the wireless power transmission system is set to 255 kHz.

FIG. 6 is a diagram illustrating voltage waveforms and a current waveform in the case where the driving frequency of the wireless power transmission system is set to 295 kHz.

FIG. 7 is a diagram illustrating voltage waveforms and a current waveform in the case where only a single series circuit formed of a switching device and a capacitor is provided.

FIG. 8 is a circuit diagram of a wireless power transmission system according to a second embodiment.

FIG. 9 is a schematic diagram of a wireless power transmission system.

FIG. 10 is a circuit diagram of another example of the wireless power transmission system according to the second embodiment.

FIG. 11 is a circuit diagram of a wireless power transmission system according to a third embodiment.

FIG. 12 is a diagram illustrating voltage waveforms and a current waveform in the third embodiment.

### DETAILED DESCRIPTION OF THE EXEMPLARY EMBODIMENTS

### First Embodiment

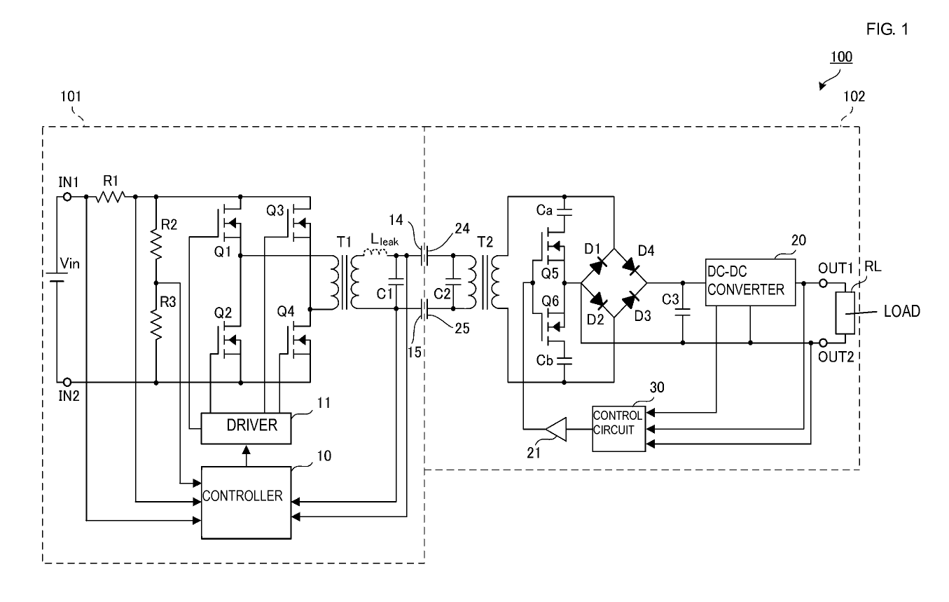

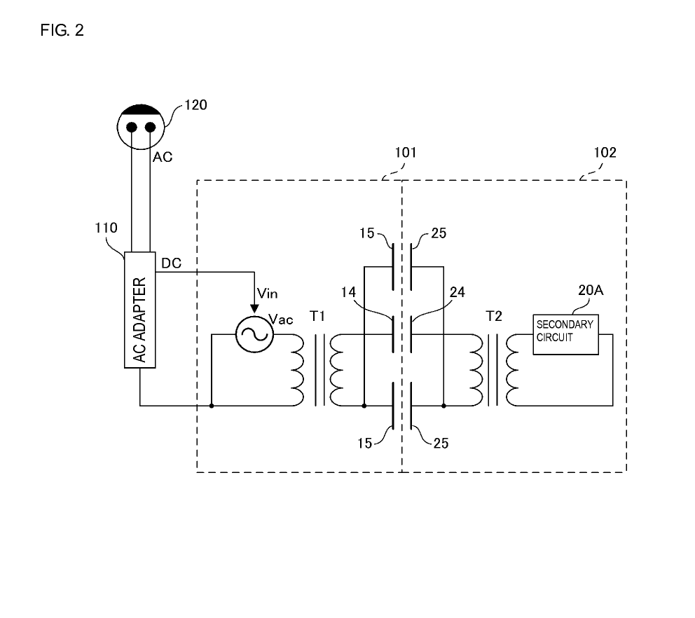

FIG. 1 is a circuit diagram of a wireless power transmission system according to a first embodiment. FIG. 2 is a schematic diagram of the wireless power transmission system.

A wireless power transmission system 100 according to the present embodiment is formed of a power transmitting apparatus 101 and a power receiving apparatus 102. The power receiving apparatus 102 includes a load RL. The load RL is a secondary battery. The power receiving apparatus 102 is, for example, a mobile electronic apparatus including the secondary battery. Examples of the mobile electronic apparatus include a cellular phone, a personal digital assistant (PDA), a mobile music player, a notebook computer, and a digital camera. The power receiving apparatus 102 is mounted on the power transmitting apparatus 101, which is a charging stand for charging the secondary battery of the power receiving apparatus 102.

The power transmitting apparatus 101 is connected to a power supply 120 through an AC adapter 110, as illustrated in FIG. 2. The power supply 120 is, for example, an AC 100-230 V home electrical outlet. The AC adapter 110 converts AC 100-230 V into DC 5 V or 12 V and outputs it to the power transmitting apparatus 101. The power transmitting apparatus 101 operates on an input DC voltage Vin serving as a power supply voltage. The power transmitting apparatus 101 converts the DC voltage Vin into an AC voltage Vac and steps it up using a step-up transformer T1. The power transmitting apparatus 101 applies the stepped-up AC voltage between an active electrode 14 and a passive electrode 15. The frequency of this AC voltage ranges from 100 kHz to 10 MHz.

The power receiving apparatus 102 includes an active electrode 24 and a passive electrode 25. The active electrode 24 and the passive electrode 25 respectively face the active electrode 14 and the passive electrode 15 of the power transmitting apparatus 101 with a gap therebetween when the power receiving apparatus 102 is mounted on the power transmitting apparatus 101. Note that the passive electrodes 15 and 25 may be in direct contact with each other. As a result of a voltage being applied between the active electrode 14 and the passive electrode 15, an electric field is generated between the active electrodes 14 and 24 arranged so as to face each other, and power is transmitted from the power transmitting apparatus 101 to the power receiving apparatus 102 via this electric field. In the power receiving apparatus 102, an AC voltage induced by the power transmission is applied to a secondary circuit 20A, after having been stepped down by a step-down transformer T2, and is rectified and smoothed by the secondary circuit 20A.

Referring back to FIG. 1, a DC-AC inverter circuit formed of switching devices Q1, Q2, Q3, and Q4 is connected between input terminals IN1 and IN2 of the power transmitting apparatus 101 via a resistor R1 for current detection and voltage dividing resistors R2 and R3 for voltage detection. The switching devices Q1, Q2, Q3, and Q4 are n-type MOS-FETs. The switching devices Q1 and Q2 are connected in series with each other and the switching devices Q3 and Q4 are connected in series with each other. The primary coil of the step-up transformer T1 is connected between a connection node between the switching devices Q1 and Q2 and a connection node between the switching devices Q3 and Q4.

Control signals are applied from a driver 11 to the gates of the switching devices Q1, Q2, Q3, and Q4. The driver 11 alternately switches on/off the switching devices Q1 and Q4 and the switching devices Q2 and Q3 in accordance with driving signals provided by a controller 10.

The active electrode 14 and the passive electrode 15 are connected to the secondary coil of the step-up transformer T1 and an AC voltage stepped up by the step-up transformer T1 is applied between the active electrode 14 and the passive electrode 15. A capacitor C1 is connected in parallel with the secondary coil, and the capacitor C1 and a leakage inductor Lₗₑₐₖ of the step-up transformer T1 form a series resonant circuit.

The controller 10 detects a transmission current, a transmission voltage, and the like, in the power transmitting apparatus 101, and determines whether or not power transmission is allowed, and generates a control signal for the driver 11. Further, the controller 10, for example, changes transmission power by changing, for example, the duty ratio of the switching devices Q1-Q4. The controller 10 will be described in more detail later.

The primary coil of the step-down transformer T2 is connected to the active electrode 24 and the passive electrode 25 of the power receiving apparatus 102. A capacitor C2 is connected in parallel with this primary coil, thereby forming a parallel resonant circuit. A diode bridge formed of diodes D1, D2, D3, and D4 is connected to the secondary coil of the step-down transformer T2.

In more detail, the cathode of the diode D1 is connected to the anode of the diode D4, and the anode of the diode D1 is connected to the anode of the diode D2. The cathode of the diode D4 is connected to the cathode of the diode D3 and the cathode of the diode D2 is connected to anode of the diode D3. A connection node between the diodes D1 and D4 and a connection node between the diodes D2 and D3 are connected to the secondary coil of the step-down transformer T2.

A connection node between the diodes D3 and D4 is connected to an output terminal OUT1 through a smoothing capacitor C3 and a DC-DC converter 20. A connection node between the diodes D1 and D2 is connected to an output terminal OUT2. The load RL, which is a secondary battery, is connected to the output terminals OUT1 and OUT2.

The power receiving apparatus 102 includes a communication circuit for transmitting data from the power receiving apparatus 102 to the power transmitting apparatus 101. The communication circuit includes switching devices Q5 and Q6, capacitors Ca and Cb, and a driver circuit 21. The switching devices Q5 and Q6 are n-type MOS-FETs. The drain of the switching device Q5 is connected to a connection node between the diodes D1 and D4 through the capacitor Ca, and the source of the switching device Q5 is connected to a connection node between the diodes D1 and D2. The source of the switching device Q6 is connected to a connection node between the diodes D1 and D2, and the drain of the switching device Q6 is connected to a connection node between the diodes D2 and D3 through the capacitor Cb. In other words, a configuration is formed in which a series circuit formed of the capacitor Ca and the switching device Q5 is connected in parallel with the diode D1 and a series circuit formed of the capacitor Cb and the switching device Q6 is connected in parallel with the diode D2.

The series circuit formed of the capacitor Ca and the switching device Q5 and the series circuit formed of the capacitor Cb and the switching device Q6 correspond to the “first series circuits” according to the present invention.

The gates of the switching devices Q5 and Q6 are connected to a control circuit (control means of the present invention) 30 through the driver circuit 21. The control circuit 30 detects a current flowing in the DC-DC converter 20 and a voltage output from the output terminals OUT1 and OUT2, and thereby detects the state of the power receiving apparatus 102, for example, the charge level of a secondary battery. Then to transmit information about the detected charge level to the power transmitting apparatus 101, the control circuit 30 generates and outputs a modulation signal. The output modulation signal is applied to the gates of the switching devices Q5 and Q6 through the driver circuit 21, whereby the switching devices Q5 and Q6 are simultaneously switched on/off.

The diodes D1 and D2 enter a state of being bypassed by the capacitors Ca and Cb when the switching devices Q5 and Q6 are simultaneously switched on, and enter an open state when the switching devices Q5 and Q6 are simultaneously switched off. In other words, a load impedance on the power receiving apparatus 102 side as seen from the power transmitting apparatus 101 side changes in accordance with the on/off state of the switching devices Q5 and Q6. This change in the load impedance is utilized to transmit binary data from the power receiving apparatus 102 to the power transmitting apparatus 101. For example, to transmit data “1” to the power transmitting apparatus 101, the load impedance on the power receiving apparatus 102 side as seen from the power transmitting apparatus 101 side is made to enter a first state (for example, an H level), and to transmit data “0” to the power transmitting apparatus 101, the load impedance is made to enter a second state (for example, an L level). The transmission current at the power transmitting apparatus 101 is increased in the case of the first state, and the transmission current at the power transmitting apparatus 101 is decreased in the case of the second state.

On the power transmitting apparatus 101 side, the controller 10 reads this change in the transmission current, i.e., DC current input at an input terminal IN1, and can thereby determine whether the data is “1” or “0”. In this manner, the controller 10 obtains information transmitted from the power receiving apparatus 102, for example, information about the charge level of the secondary battery.

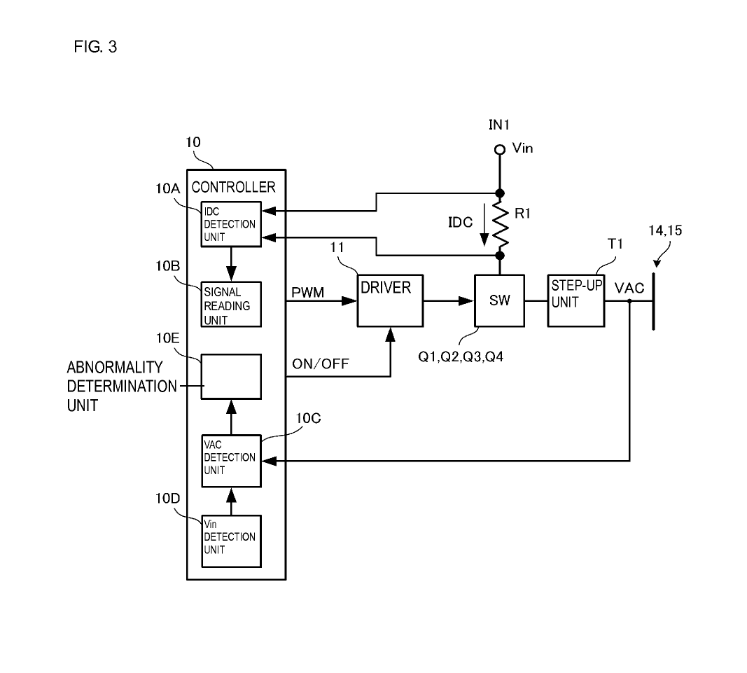

FIG. 3 is a block diagram for describing the controller 10 of the power transmitting apparatus 101. The controller 10 includes an IDC detection unit 10A, a signal reading unit 10B, a VAC detection unit 10C, a Vin detection unit 10D, and an abnormality determination unit 10E.

The IDC detection unit 10A detects a DC current IDC. Specifically, the IDC detection unit 10A detects a DC current input at the input terminal IN1 on the basis of a voltage across the resistor R1. The signal reading unit 10B reads the value of the DC current IDC detected by the IDC detection unit 10A. The DC current IDC changes in accordance with the on/off states of the switching devices Q5 and Q6 on the power receiving apparatus 102 side. On the basis of these changes, the signal reading unit 10B reads binary data created on the power receiving apparatus 102 side, and reads information transmitted from the power receiving apparatus 102, for example, information about the charge level of the secondary battery. The signal reading unit 10B reads transmitted data on the basis of changes in the DC current IDC and, hence, complex signal processing is not needed in the controller 10.

The VAC detection unit 10C detects a transmission voltage VAC. The Vin detection unit 10D detects the DC voltage Vin input at the input terminals IN1 and IN2. The abnormality determination unit 10E detects system abnormality on the basis of the transmission voltage VAC detected by the VAC detection unit 10C and the DC voltage Vin detected by the Vin detection unit 10D. For example, when an abnormal object is mounted on the power transmitting apparatus 101, the abnormality determination unit 10E determines the occurrence of abnormality on the basis of the amount of change in the transmission voltage VAC.

The controller 10, on the basis of the information read by the signal reading unit 10B or the determination result obtained by the abnormality determination unit 10E, adjusts generation of a PWM signal and outputs the PWM signal to the driver 11, thereby controlling the switching of the switching devices Q1 to Q4, or terminates the operation of the driver 11, thereby switching off the switching devices Q1 to Q4 and terminating power transmission.

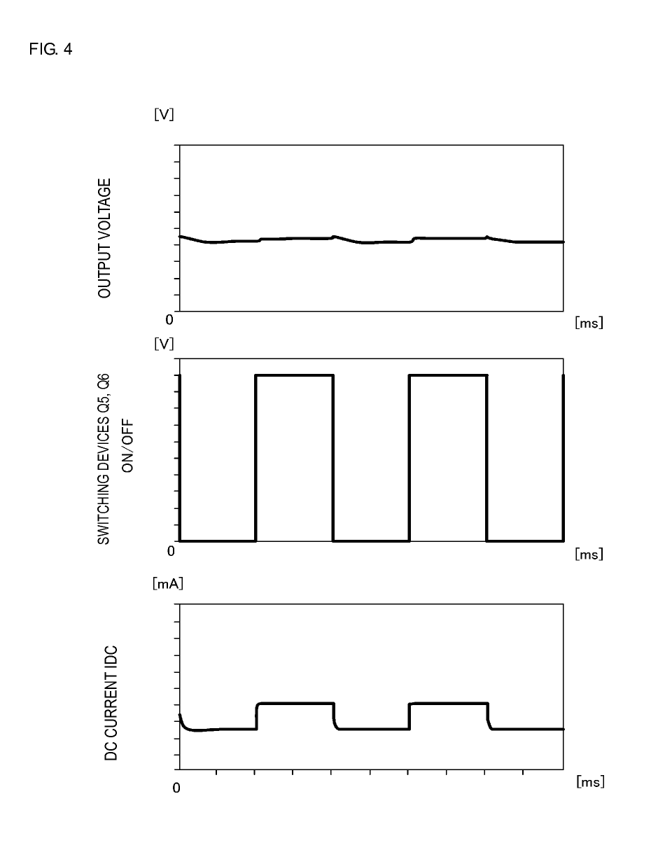

FIG. 4 is a diagram illustrating voltage waveforms and a current waveform in the first embodiment. FIG. 4 illustrates, from top to bottom, the waveforms of the output voltage of the diode bridge, the gate-source voltage of the switching devices Q5 and Q6, and the DC current IDC. As can be seen from FIG. 4, as a result of the switching devices Q5 and Q6 being switched on/off, the waveform of the DC current IDC becomes a modulation waveform close to a square wave. The controller 10 detects this modulated DC current IDC, and thereby reads the binary data created on the power receiving apparatus 102 side. Although the switching devices Q5 and Q6 are switched on/off, the ripple of the output voltage of the diode bridge is small. This is due to the fact that a resonant circuit is provided on the power transmitting apparatus 101 side, a resonant circuit is provided also on the power receiving apparatus 102 side, which are capacitively coupled to each other, and the system is operated near the central coupling resonant frequency (characteristic, or natural frequency), and also due to the fact that the modulation portion including the resonant circuit and the load circuit are DC-separated from each other by the diode bridge.

In this manner, in the present embodiment, data communication from the power receiving apparatus 102 to the power transmitting apparatus 101 can be performed in such a manner that the ripple component of an output voltage is suppressed, and further, the data communication can be performed while power is being fed.

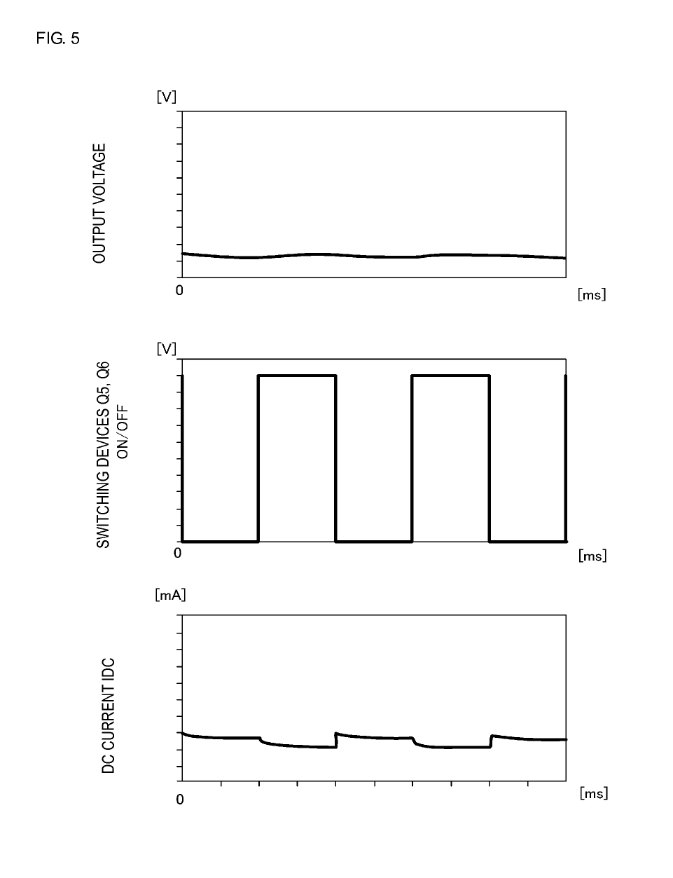

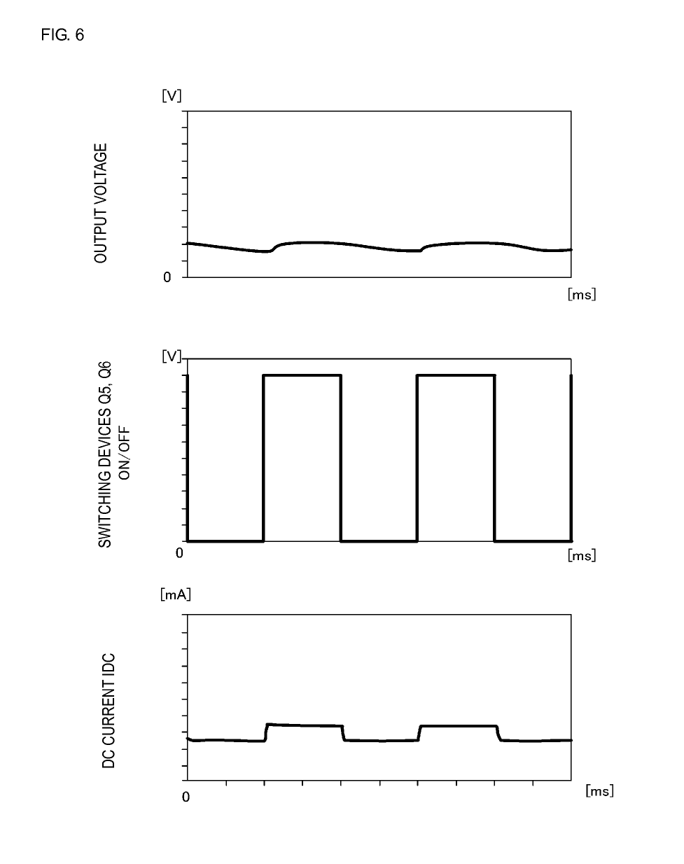

Next, dependency of the wireless power transmission system 100 according to the first embodiment on the driving frequency will be described. FIG. 4 described above is a diagram illustrating the voltage waveforms and current waveform at the time when the resonant frequency on the power receiving apparatus 102 side is set to the driving frequency, 275 kHz, of the wireless power transmission system 100. FIG. 5 is a diagram illustrating the voltage waveforms and current waveform at the time when the driving frequency of the power transmission system 100 is set to 255 kHz. FIG. 6 is a diagram illustrating the voltage waveforms and current waveform at the time when the driving frequency of the power transmission system 100 is set to 295 kHz.

As can be seen from the comparison of FIG. 4 with FIG. 5 and FIG. 6, when the resonant frequency on the power receiving apparatus 102 is set to the driving frequency of the wireless power transmission system 100, the output voltage is larger than in the other cases. Further, when the driving frequency is lower than the resonant frequency (FIG. 5), the degree of modulation is degraded. Therefore, it is preferable that the resonant frequency on the power receiving apparatus 102 side be set to the driving frequency of the wireless power transmission system 100.

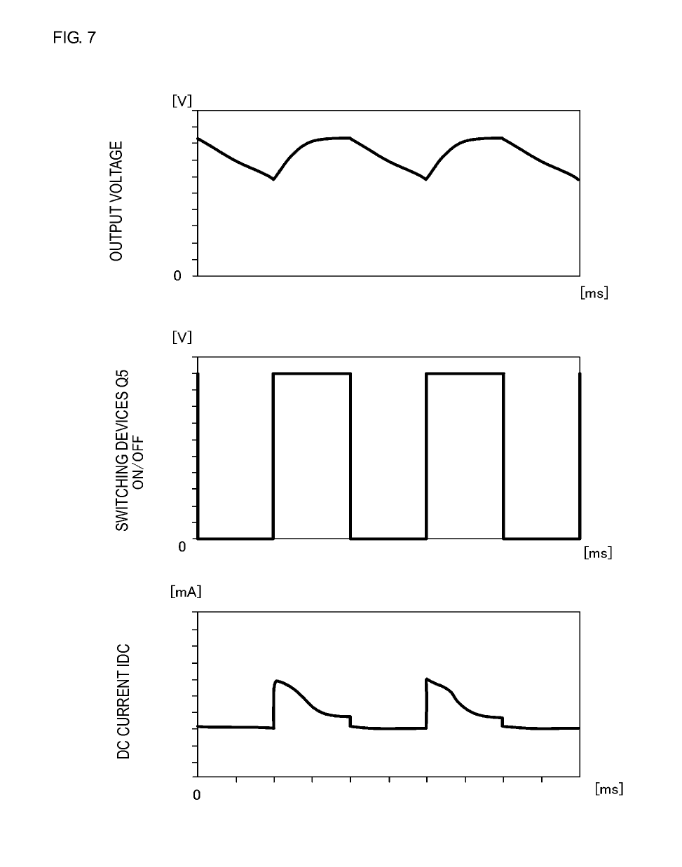

Next, comparison of the present embodiment with a case in which only a single series circuit formed of a switching device and a capacitor is provided on the power receiving apparatus 102 side will be described. FIG. 7 is a diagram illustrating voltage waveforms and a current waveform in the case in which only a single series circuit formed of the switching device Q6 and the capacitor Cb is provided. In FIG. 7, the waveforms of the output voltage of the diode bridge, the gate-source voltage of the switching device Q5, and the DC current IDC are illustrated, from top to bottom. In this case, a bypass path formed of the capacitor Ca is formed via the diode D1, and a bypass path is no longer formed for the diode D2. Hence, when the switching device Q5 is switched on, a half of the rectifying operations is lost, whereby the waveform of the DC current IDC becomes asymmetric and the ripple of the output voltage is increased, as illustrated in FIG. 7.

As described above, in the wireless power transmission system 100 according to the first embodiment, data can be transmitted from the power receiving apparatus 102 to the power transmitting apparatus 101 while reducing the ripple component generated in the output voltage, by respectively providing series circuits, each formed of a switching device and a capacitor, in parallel with the two diodes D1 and D2 of the diode bridge, and by simultaneously switching the switching devices on/off.

### Second Embodiment

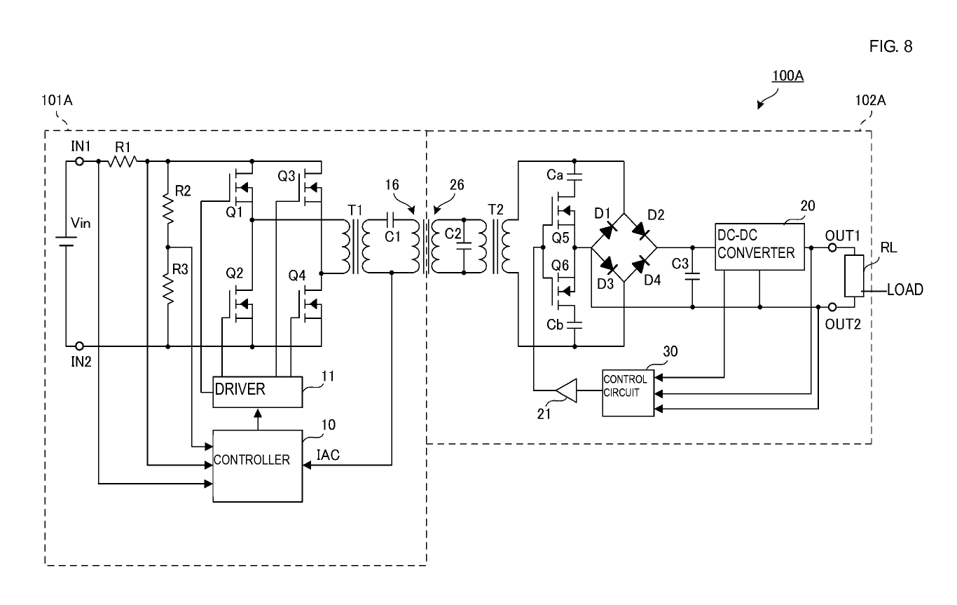

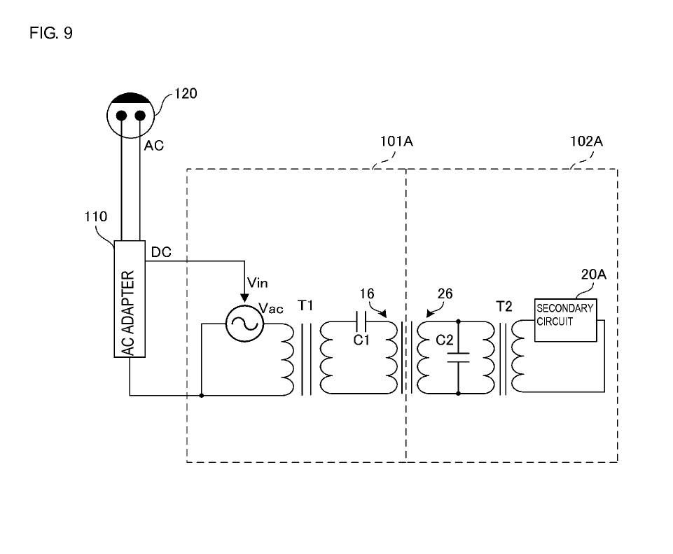

FIG. 8 is a circuit diagram of a wireless power transmission system according to a second embodiment. FIG. 9 is a schematic diagram of a wireless power transmission system. The wireless power transmission system 100 according to the first embodiment transmits power using electric field coupling. However, a wireless power transmission system 100A according to the second embodiment transmits power using magnetic field coupling.

In a power transmitting apparatus 101A, a power transmitting side coupling coil (power transmitting side coil of the present invention) 16 is connected to the secondary coil of the step-up transformer T1. The power transmitting side coupling coil 16 and the capacitor C1 form a series resonant circuit. In a power receiving apparatus 102A, a power receiving side coupling coil (power receiving side coil of the present invention) 26, in which a high-frequency current is induced due to electromagnetic induction between the power receiving side coupling coil 26 and the power transmitting side coupling coil 16, is connected to the primary coil of the step-down transformer T2. The power receiving side coupling coil 26 and the capacitor C2 form a parallel resonant circuit. The rest of the configurations of the power transmitting apparatus 101A and the power receiving apparatus 102A is similar to that of the first embodiment. A detector for detecting an AC current IAC of the series resonant circuit is provided and a detection result is input to the controller 10.

The controller 10 includes an IAC detection unit in addition to the functional units described in FIG. 3. The abnormality determination unit of the controller 10 detects abnormality of the system on the basis of the DC current IDC detected by the IDC detection unit or the transmission voltage VAC detected by the VAC detection unit (or the transmission AC current IAC detected by the IAC detection unit), and the DC voltage Vin detected by the Vin detection unit. For example, when an abnormal object is mounted on the power transmitting apparatus, the abnormality determination unit determines the occurrence of abnormality on the basis of the amount of change in the DC current IDC or the amount of change in the transmission voltage VAC (or the amount of change in the transmission AC current IAC).

The wireless power transmission system 100A according to the second embodiment, similarly to the first embodiment, transmits data from the power receiving apparatus 102A to the power transmitting apparatus 101A, by simultaneously switching the switching devices Q5 and Q6 on/off. In this manner, also in the case in which power is transmitted as a result of the power transmitting apparatus 101A and the power receiving apparatus 102A being magnetically coupled to each other, data can be transmitted without interrupting power transmission. Further, data can be transmitted from the power receiving apparatus 102A to the power transmitting apparatus 101A while reducing the ripple generated in the output voltage.

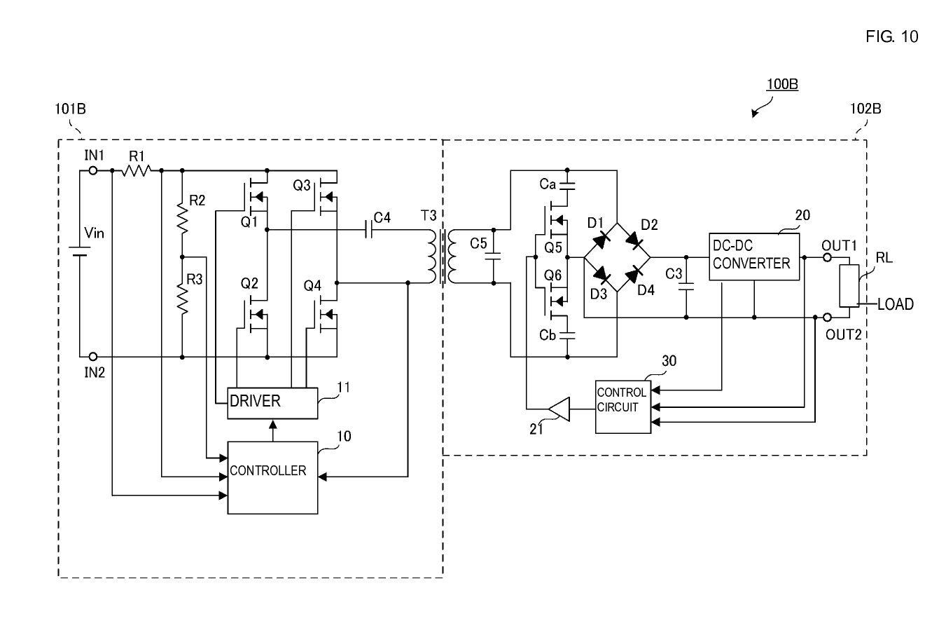

FIG. 10 is a circuit diagram of another example of the wireless power transmission system 100A according to the second embodiment. In a wireless power transmission system 100B of this example, a power transmitting apparatus 101B does not have a step-up transformer. One end of the power transmitting side coupling coil 16 is connected to a connection node between the switching devices Q1 and Q2 through a capacitor C4 that forms part of a series resonant circuit, and the other end is connected to a connection node between the switching devices Q3 and Q4.

The power receiving apparatus 102B does not have a step-down transformer. One end of the power receiving side coupling coil 26 is connected to a connection node between the diodes D1 and D2, and the other end is connected to a connection node between the diodes D3 and D4. The power receiving side coupling coil 26 and a capacitor C5 form a parallel resonant circuit.

### Third Embodiment

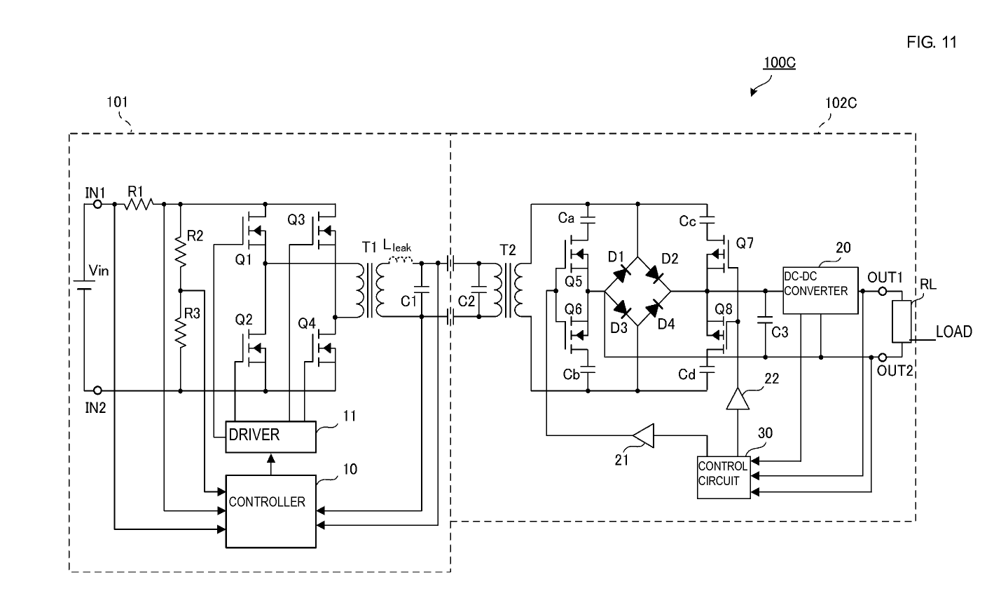

FIG. 11 is a circuit diagram of a wireless power transmission system according to a third embodiment. The power transmitting apparatus 101 provided in a wireless power transmission system 100C according to the third embodiment is similar to that of the first embodiment. A power receiving apparatus 102C has a configuration in which a series circuit formed of a switching device Q7 and a capacitor Cc and a series circuit formed of a switching device Q8 and a capacitor Cd are respectively connected in parallel with the diodes D2 and D4 of the power receiving apparatus 102 according to the first embodiment. In the third embodiment, four-level (four-value) data can be transmitted from the power receiving apparatus to the power transmitting apparatus, thereby enabling high-rate information transmission, whereas binary data is transmitted in the first and second embodiments.

A series circuit formed of the switching device Q7 and the capacitor Cc and a series circuit formed of the switching device Q8 and the capacitor Cd correspond to the “second series circuits” according to the present invention.

Switching devices Q7 and Q8 are p-type MOS-FETs, and a modulation signal is applied to the gates from the control circuit 30 via a buffer circuit 22. Note that the switching devices Q7 and Q8 may be n-type MOS-FETs. In this case, a bootstrap circuit is provided to drive the switching devices Q7 and Q8.

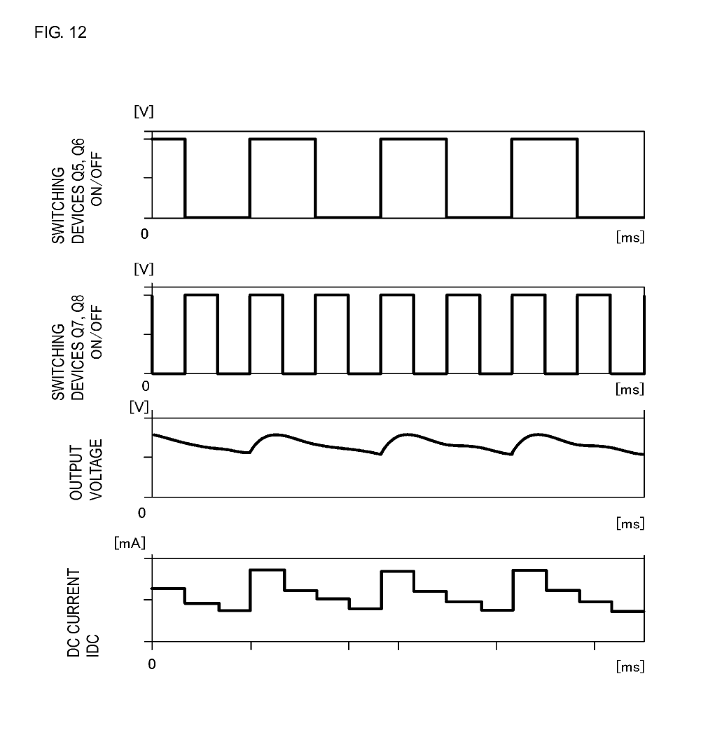

FIG. 12 is a diagram illustrating voltage waveforms and a current waveform in the third embodiment. In FIG. 12, the waveforms of the gate-source voltage of the switching devices Q5 and Q6, the gate-source voltage of the switching devices Q7 and Q8, the output voltage of the diode bridge, and the DC current IDC are illustrated, from top to bottom. In this example, the switching devices Q5 and Q6 and the switching devices Q7 and Q8 are repeating four-level load modulation, and the waveform of the DC current IDC is a modulation waveform having a four-state square wave. Further, the ripple of the output voltage of the diode bridge is small.

In this manner, four-value data can be transmitted by respectively connecting series circuits, each formed of a switch device and a capacitor, in parallel with the diodes D1, D2, D3, and D4 of the diode bridge of the wireless power transmission system 100C and by performing switching control of the series circuits at different frequencies. Note that a configuration may be employed in which only a series circuit formed of the switching devices Q7 and Q8 and the capacitors Cc and Cd is provided, without providing the series circuit formed of the switching devices Q5 and Q6 and the capacitors Ca and Cb.

### REFERENCE SIGNS LIST

10—controller (signal reading means)
10A—IDC detection unit
10B—signal reading unit (signal reading means)
10C—VAC detection unit
10D—Vin detection unit
10E—abnormality determination unit
11—driver
14—active electrode (power transmitting unit)
15—passive electrode (power transmitting unit)
16—power transmitting side coupling coil (power transmitting unit, power transmitting side coil)
20—DC—DC converter
24—active electrode (power receiving unit)
25—passive electrode (power receiving unit)
26—power receiving side coupling coil (power receiving unit, power receiving side coil)
30—control circuit (control means)
100, 100A, 100B, 100C—wireless power transmission systems
101, 101A, 101B—power transmitting apparatuses
102, 102A, 102B, 102C—power receiving apparatuses
110—AC adapter
120—power supply
C1, C2, C3, Ca, Cb, Cc, Cd—capacitors
D1—diode (first diode)
D2—diode (second diode)
D3—diode (third diode)
D4—diode (fourth diode)
Q5, Q6, Q7, Q8—switching devices (semiconductor switching devices)
T1—step-up transformer
T2—step-down transformer
IN1, IN2—input terminals
OUT1, OUT2—output terminals
RL—load

1. A wireless power transmission system comprising:
a power transmitting apparatus including an active electrode and a passive electrode; and
a power receiving apparatus that includes an active electrode and a passive electrode and that is configured to receive power from an electric field generated between the respective active electrodes when the power receiving apparatus is positioned on the power transmitting apparatus, the power receiving apparatus comprising:
a diode bridge including first and second diodes with respective anodes that are coupled to each other, and third and fourth diodes with respective cathodes that are coupled to each other;
a pair of first series circuits, each having a semiconductor switching device and a capacitor, with each first series circuit coupled in parallel with the first and second diodes, respectively;
a control circuit configured to output a modulation signal to respective control terminals of the semiconductor switching devices to control an operating state of the pair of first series circuits, and
wherein a load impedance detected by the power transmitting apparatus is based at least partially on the operating state of the pair of first series circuits.

2. The wireless power transmission system according to claim 1, wherein the power receiving apparatus is configured to convert an AC voltage induced in the active and passive electrodes of the power receiving apparatus to a DC voltage by rectifying and smoothing the AC voltage.

3. The wireless power transmission system according to claim 1, wherein the power transmitting apparatus is configured to adjust a transmission current based on a detected change of the load impedance generated by the power receiving apparatus.

4. The wireless power transmission system according to claim 4, wherein the power transmitting apparatus comprises a controller configured to determine a data signal based on a change in a transmission current.

5. The wireless power transmission system according to claim 4, wherein the power transmitting apparatus includes:
a DC-AC inverter; and
a step-up circuit configured to step up an AC voltage output from the DC-AC inverter and to apply the stepped-up AC voltage to the active and passive electrodes of the power transmitting apparatus.

6. The wireless power transmission system according to claim 5, wherein the controller is configured to detect the change in the transmission current based on a change in a current input to the power transmitting apparatus.

7. The wireless power transmission system according to claim 1, wherein the power receiving apparatus further comprises a pair of second series circuits, each having a semiconductor switching device and a capacitor, with each second series circuit coupled in parallel with the third and fourth diodes, respectively.

8. The wireless power transmission system according to claim 7, wherein the control circuit outputs the modulation signal to the respective control terminals of the semiconductor switching devices of the pairs of first and second series circuits to control the operating state of the pairs of first and second series circuits.

9. The wireless power transmission system according to claim 1, wherein the active electrode of the power receiving apparatus faces the active electrode of the power transmitting apparatus with a gap therebetween when the power receiving apparatus is positioned on the power transmitting apparatus,
wherein the passive electrode of the power receiving apparatus faces the passive electrode of the power transmitting apparatus with a gap therebetween or is in direct contact with the passive electrode of the power transmitting apparatus when the power receiving apparatus is positioned on the power transmitting apparatus, and
wherein power is transmitted through the electric field from the power transmitting apparatus to the power receiving apparatus by the respective active electrodes facing each other.

10. The wireless power transmission system according to claim 1,
wherein the power transmitting apparatus further comprises a power transmitting side coil through which a high-frequency current flows,
wherein the power receiving apparatus further comprises a power receiving side coil in which a high-frequency current is induced by electromagnetic induction, and
wherein power is transmitted from the power transmitting apparatus to the power receiving apparatus based on magnetic field coupling between the power transmitting side coil and the power receiving side coil.

11. The wireless power transmission system according to claim 10, wherein the power transmitting side coil is further coupled to the active and passive electrodes of the power transmitting apparatus with a capacitor coupled in parallel to the active and passive electrodes and an inductor coupled in series between the power transmitting side coil and the active electrode.

12. The wireless power transmission system according to claim 10, wherein the power transmitting side coil is further coupled to the active and passive electrodes of the power transmitting apparatus with a capacitor coupled in series between the power transmitting side coil and the active electrode, wherein the power receiving side coil is further coupled to the active and passive electrodes of the power receiving apparatus with a capacitor coupled in parallel to the active and passive electrodes of the power receiving apparatus.

13. The wireless power transmission system according to claim 1, wherein the power receiving apparatus further comprises a smoothing capacitor and a DC-to-DC converter that are each coupled in parallel between the anodes of the first and second diodes and the cathodes of the third and fourth diodes.

14. The wireless power transmission system according to claim 13, wherein a battery of the power receiving apparatus is coupled to an output of the DC-to-DC converter to receive power from the electric field that is generated between the respective active electrodes when the power receiving apparatus is positioned on the power transmitting apparatus.

15. The wireless power transmission system according to claim 14, wherein the control circuit is communicatively coupled to the battery and the modulation signal is output by the control circuit based at least partly on a charge level of the battery.

16. A power receiving apparatus comprising:
an active electrode and a passive electrode that induce an AC voltage when the power receiving apparatus is positioned on a power transmitting apparatus having an active electrode and a passive electrode;
a diode bridge that includes first and second diodes with respective anodes that are coupled to each other, and third and fourth diodes with respective cathodes that are coupled to each other;
a pair of first series circuits, each having a semiconductor switching device and a capacitor, with each first series circuit coupled in parallel with the first and second diodes, respectively, and
a control circuit configured to output a modulation signal to respective control terminals of the semiconductor switching devices to control an operating state of the pair of first series circuits;
wherein the power receiving apparatus provides a load impedance that is detected by the power transmitting apparatus when the power receiving apparatus is positioned on the power transmitting apparatus, and the load impedance is based at least partially on the operating state of the pair of first series circuits.

17. The power receiving apparatus according to claim 16, wherein the power receiving apparatus is configured to convert an AC voltage induced in the active and passive electrodes to a DC voltage by rectifying and smoothing the AC voltage.

18. The power receiving apparatus according to claim 16, further comprising a smoothing capacitor and a DC-to-DC converter that are each coupled in parallel between the anodes of the first and second diodes and the cathodes of the third and fourth diodes.

19. The power receiving apparatus according to claim 18, further comprising a battery that is coupled to an output of the DC-to-DC converter to receive power from the electric field that is generated between the respective active electrodes of the power receiving and transmitting apparatuses when the power receiving apparatus is positioned on the power transmitting apparatus.

20. The power receiving apparatus according to claim 19, wherein the control circuit is communicatively coupled to the battery and the modulation signal is output by the control circuit based at least partly on a charge level of the battery.
